(19) United States
(12) Patent Application Publication
(10) Pub. No.: US 2022/0007573 A1
(43) Pub. Date: Jan. 13, 2022

(54) CUTTING BLADE FOR A CUTTER HEAD AND CUTTER HEAD FOR A BRUSHCUTTER

(71) Applicant: Andreas Stihl AG & Co. KG, Waiblingen (DE)

(72) Inventors: Johannes Kloepfer, Remseck am Neckar (DE); Markus Hittmann, Weinstadt (DE); Achim Rethaber, Fellbach (DE); Philipp Mueller, Osterburken (DE); Roland Mandel, Stuttgart (DE); Antje Kielczyk, Steinheim (DE)

(21) Appl. No.: 17/362,534

(22) Filed: Jun. 29, 2021

(30) Foreign Application Priority Data
Jul. 7, 2020 (EP) 20 184 519.5

(51) Int. Cl. A01D 34/73; A01D 34/82

(52) U.S. Cl. CPC A01D 34/733; A01D 34/82

(57) ABSTRACT

The disclosure is directed to a cutting blade for a cutter head and includes a base body having a fastening arrangement for fastening the cutting blade to a cutter head as well as a blade edge. The base body and the blade edge are made of a biodegradable natural substance. Alternatively, the base body is made of a non-biodegradable plastic and the blade edge is made at least in part of a biodegradable material.

### CROSS REFERENCE TO RELATED APPLICATION

This application claims priority of European patent application no. 20 184 519.5, filed Jul. 7, 2020, the entire content of which is incorporated herein by reference.

### TECHNICAL FIELD

The disclosure relates to a cutting blade for attachment to a cutter head of a brushcutter. The disclosure also relates to the cutter head.

### BACKGROUND

Cutter heads for a brushcutter are known, which include a main body and a cutting blade held at a fastening receptacle of the main body. Such cutting blades are usually formed in one piece and produced from a plastic by means of injection-molding processes. A drawback of such cutting blades is that the plastic is not biodegradable. During operation of such a cutting blade, very small particles arise as a result of abrasion, these passing into the natural environment but not degrading there. Such particles of plastic represent an environmental burden.

### SUMMARY

It is an object of the invention to provide a cutting blade that is more environmentally friendly.

It is a further object of the invention to provide a cutter head such that more environmentally friendly operation of the cutter head on a brushcutter is made possible.

The cutting blade according to the disclosure includes a base body having a fastening arrangement for fastening the cutting blade to a cutter head, and a blade edge. The base body and the blade edge are made of a biodegradable natural substance.

In a further embodiment, the base body is made of a non-biodegradable plastic, the blade edge being made at least in part of a biodegradable material. The cutting blade is part of the cutter head. The cutter head includes a main body, the main body being drivable in rotation about its rotational axis during operation of the brushcutter. At least one fastening receptacle is provided on the main body, the cutting blade being held at the fastening receptacle.

During operation of the cutter head, the cutting blade cuts scrub, grasses and the like. The blade edge of the cutting blade is the part of the cutting blade that acts on the material to be cut and is exposed to the greatest loading. Among the loading, abrasion at the blade edge occurs, with the result that very small particles are detached from the blade edge and drop to the ground. Since the blade edge consists of a biodegradable material, the detached particles decompose, thereby avoiding an environmental burden. As a result, a brushcutter having the cutting blade can be operated in a more environmentally friendly manner.

The biodegradable material is preferably a material in particular from the group consisting of biodegradable natural materials and biodegradable plastics. These materials have the common factor that they decompose entirely and no microplastic arises. The blade edge consists preferably of a wood material, in particular of a hardwood. Wood materials are understood to be materials produced from wood, for example solid wood, glued solid wood, veneer wood, multiplex boards, plywood, fiberboard. Fiberboards include, inter alia, particle boards, oriented strand boards, MDF. As a result of the use of hardwood, the blade edge has a particularly high resistance, which results in a long service life of the blade edge and of the cutting blade.

Provision is advantageously made for the blade edge to be formed on the base body. The blade edge and the base body are preferably formed in one piece and consist of the same material. Even in the case of a worn blade edge, no environmentally harmful pieces detach from the base body, since the latter is likewise formed from correspondingly biodegradable natural material. Even when the entire cutting blade is replaced, only environmentally compatible residual waste arises.

Provision is advantageously made for the base body to comprise a carrier and a cutting insert, the cutting insert being held by the carrier and the blade edge being arranged on the cutting insert. This allows the use of different materials for the cutting blade. Thus, an appropriate material can be chosen in a manner specific to the loading that arises at the cutting blade. Thus, the carrier is formed preferably from a non-biodegradable plastic. The fastening arrangement can, in particular as in established solid plastic blades, be in the form of an opening in the base body. Such a plastic has a high strength and corresponding anti-friction properties, which are advantageous particularly for the fastening arrangement. The cutting insert consists preferably of a biodegradable material.

The blade edge is preferably formed on the cutting insert. Preferably, the cutting insert and the blade edge are formed in one piece from the same material. When the blade edge is worn, it is sufficient to replace only the cutting insert. By contrast, the carrier can be reused.

The cutting insert is at least partially overmolded by the carrier. The cutting insert is preferably held on the carrier in a form-fitting manner in the longitudinal direction of the cutting blade. The abovementioned connecting techniques between the carrier and cutting insert can also be combined. As a result, particularly high bonding forces between the carrier and cutting insert can be produced. This allows particularly robust operation of the cutting blade.

Provision is advantageously made for at least one cutout, in particular at least one slot, to be provided in the base body. Such cutouts serve to increase the elasticity of the base body. In the event of impact loading on the blade edge, the supporting structure of the base body deflects as a result of the cutouts and the impact is damped. This reduces the loading acting on the blade edge. Furthermore, the cutouts in the base body also bring about a weight reduction and thus reduce the inertia of the cutting blade. Preferably, the cutouts are provided in the cutting insert. If the cutting insert provided with the cutouts is overmolded by the carrier, a form fit between the cutting insert and carrier is created by the cutouts.

Provision is preferably made for the blade edge to be formed from two outer layers and an inner layer arranged between the two outer layers, the outer layers having a lower strength than the inner layer. In the event of loading on the blade edge, the outer layers are worn down first, with the result that a wedge-like cross-sectional contour of the blade edge is formed. Accordingly, self-sharpening of the blade edge occurs during operation of the cutting blade. The outer layers and the inner layer can also each consist of a plurality of individual layers.

The blade edge preferably has a water-repellent coating. As a result, the wear at the blade edge caused by moisture is reduced and the service life of the cutting blade is increased.

Provision is advantageously made for the cutter head to have an underside that faces the ground in the working posture of the brushcutter, the underside of the cutter head made of a biodegradable material. As a result, the cutter head abrasion caused by wear is environmentally friendly.

### BRIEF DESCRIPTION OF THE DRAWINGS

The invention will now be described with reference to the drawings wherein:

FIG. 1 shows a schematic perspective view of a brushcutter having a cutter head;

FIG. 2 shows a schematic perspective view of the cutter head according to the disclosure with a cutting blade;

FIG. 3 shows a schematic plan view of a cutting blade according to the disclosure;

FIG. 4 shows a schematic elevation view of the cutting blade according to FIG. 3;

FIG. 5 shows a schematic elevation view of the cutting blade according to FIG. 3 with an alternative edge geometry;

FIG. 6 shows a schematic plan view of the cutting blade according to the disclosure with a carrier and cutting insert;

FIG. 7 shows a side view of the cutting blade according to FIG. 6;

FIG. 8 shows a schematic plan view of a cutting blade with a cutting insert held in a form-fitting manner;

FIG. 9 shows a section view of the cutting blade along the arrows IX according to FIG. 8;

FIGS. 10 to 13 show schematic plan views of cutting blades according to the disclosure with cutouts in the cutting insert;

FIG. 14 shows a schematic section view of a multilayer blade edge;

FIG. 15 shows a schematic perspective exploded view of a blade edge with different layers; and,

FIG. 16 is a schematic plan view of a blade according to the disclosure with a changing blade edge.

### DESCRIPTION OF THE PREFERRED EMBODIMENTS

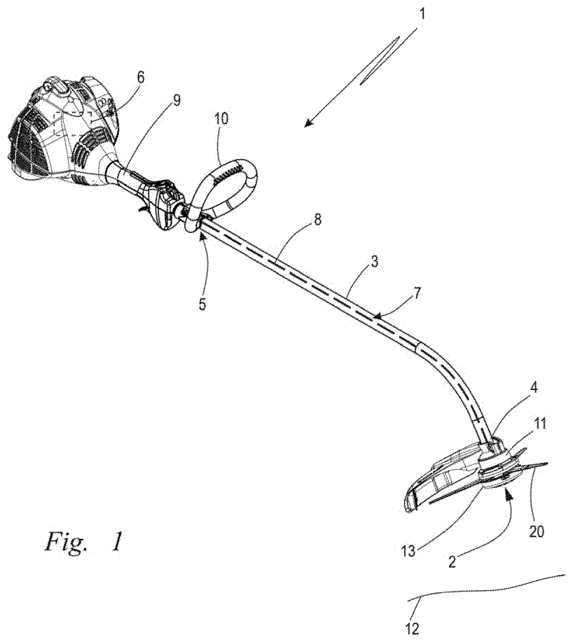

FIG. 1 is a perspective view of a handheld work apparatus 1 of the brushcutter type. A cutter head 2 is provided at a first, lower end 4 of a guide tube 3, at the second, upper end 5 of which a schematically illustrated drive motor 6 is held. The drive motor 6 drives a connecting shaft 7, which is advantageously in the form of a flexible shaft 8 and follows the curvature of the guide tube 3. Provided in the region of the upper end portion of the guide tube 3 is an operation handle 9, through which the guide tube 3 projects. Mounted next to the operation handle 9 is a bale handle 10 fastened to the guide tube 3.

The curvature of the guide tube 3 determines the working position of the cutter head 2 relative to the ground without an angular gear being necessary. Alternatively, the cutter head 2 can also be driven via an angular gear. The cutter head 2 is expediently arranged as close as possible to the first, upper end 5 of the guide tube 3 and advantageously provided with a winding protector 11 so as to avoid grass getting wrapped up in the power train. A different arrangement of the drive motor 6, in particular at the lower end 4 of the guide tube 3, may also be expedient.

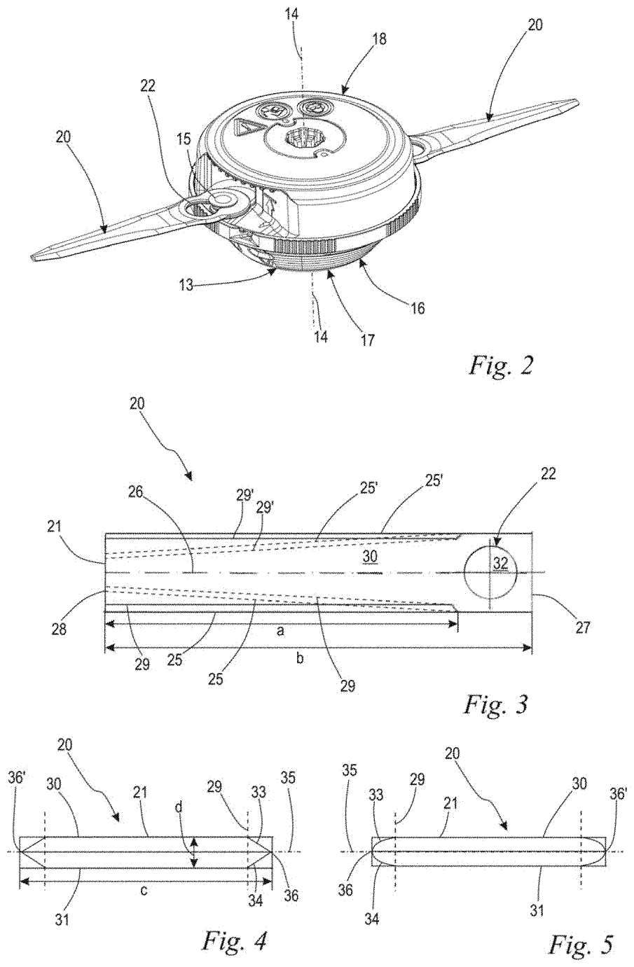

As shown in FIG. 2, the cutter head 2 comprises a main body 13 and at least one cutting blade 20 held on the main body 13. The cutter head 2 additionally comprises a fastening element for fastening the cutter head 2 to an output shaft of the handheld work apparatus 1. The fastening element may be part of the main body 13 or be in the form of an element formed separately from the main body 13. The cutter head 2 is drivable in rotation about its rotational axis 14 by the drive motor 6 via the connecting shaft 7. In the embodiment according to FIG. 2, two cutting blades 20 are fastened to the main body 13. In an alternative embodiment, it may be expedient to also fasten more than two cutting blades 20 to the main body 13, the cutting blades 20 being arranged on the main body 13 at regular angular spacings in the circumferential direction of the rotational axis 14. The cutter head 2 faces the ground 12 in the working posture of the handheld work apparatus 1. During operation of the cutter head 2, grass, scrub or the like can be cut by means of the cutting blades 20 rotating about the rotational axis 14.

As shown in FIG. 3, the cutting blade 20 comprises a base body 21 with a fastening arrangement 22 and a blade edge 25. The base body 21 extends in its longitudinal direction 26 from its first end face 27 to its second end face 28. The base body 21 comprises two longitudinal sides 29, 29′, a top side 30, and a bottom side 31, which extend from the first end face 27 to the second end face 28. In the embodiment according to FIG. 3, a blade edge 25 is arranged on each of the two longitudinal sides 29, 29′ of the base body 21. In an alternative embodiment, it may be expedient to arrange the blade edge 25, 25′ on only one of the two longitudinal sides 29, 29′, specifically on the front longitudinal side in the cutting direction.

In the embodiment according to FIG. 3, the fastening arrangement 22 is in the form of a fastening opening 32. In the preferred embodiment of the cutting blade 20, the fastening opening 32 is formed in a cylindrical manner and extends from the top side 30 to the bottom side 31 of the base body 21. The cutting blade 20 can be fastened to the main body 13 of the cutter head 2 at its fastening arrangement 22 by a fastening receptacle 15 of the cutter head 2. In the embodiment, the fastening arrangement 22 is arranged next to the first end face 27 of the base body 21. In the present embodiment, the cutting blade 20 is intended to be received via a cylindrical bearing pin of the main body 13, which passes through the cylindrical fastening opening 32 in the cutting blade 20. As a result, the cutting blade 20 is mounted in a pivotable manner on the main body 13 of the cutter head 2. If, during operation, the cutting blade 20 strikes a hard object, the cutting blade 20 can pivot back counter to the direction of rotation of the cutter head 2, with the result that damage to the cutting blade 20 is avoided.

As FIG. 2 shows, the fastening receptacle 15 arranged on the main body 13 of the cutter head 2 is in the form of a cylindrical bearing pin. The cylindrical bearing pin extends in the direction of the rotational axis 14, an access region around the cylindrical bearing pin being provided on the main body 13, allowing the cutting blade 20 to be mounted on the bearing pin. The fastening arrangement 22 of the cutting blade 20 is in the form of a keyhole opening, that is, formed with two interconnected openings of different sizes. To fasten the cutting blade 20 to the cutter head 2, the cutting blade 20 is intended to be slid onto the fastening receptacle 15 via the larger opening and subsequently pulled radially outwardly into the smaller opening away from the rotational axis 14. During operation of the cutter head 2, the cutting blade 20 is kept in the small opening of the keyhole opening by centrifugal forces.

As illustrated in FIG. 3, the blade edge 25, 25′ has a length a, measured in the longitudinal direction 26 of the cutting blade 20, that is less than the length b, measured in the longitudinal direction 26, of the cutting blade 20. The length a of the blade edge 25, 25′ corresponds preferably to at most 90%, in particular approximately 80% of the length b of the cutting blade 20. The length b of the blade edge 25, 25′ corresponds, in a state fastened to the main body 13 of the cutter head 2, preferably to the length of the cutting blade portion that protrudes radially, with respect to the rotational axis 14, from the main body 13 of the cutter head 2. This is the portion of the cutting blade 20 that comes into contact with the scrub, grass, et cetera, during operation of the cutter head 2.

FIGS. 4 and 5 show two embodiments of the cutting blade 20 with different geometries of the blade edges 25, 25′ looking at the second end face 28 of the cutting blade 20. The blade edge 25, 25′ is that part of the cutting blade 20 that is active during the cutting operation. The cutting blade 20 has a cutting plane 35 in which the cutting blade 20 is moved in a rotating manner during the cutting operation. The blade edge 25, 25′ is formed from a first cutting face 33 and a second cutting face 34, the first cutting face 33 and the second cutting face 34 being arranged in a manner tapering from the longitudinal side 29, 29′ to the cutting plane 35. In the process, the first cutting face 33 and the second cutting face 34 form a wedge-like blade edge 25, 25′. According to the embodiment of FIG. 4, the first cutting face 33 and the second cutting face 34 taper in a wedge-like manner and form a cutting edge 36.

According to the embodiment of FIG. 5, the first cutting face 33 and the second cutting face 34 are formed in an arcuate manner in cross section through the cutting blade 20, with the result that the cutting edge 36 is rounded. In alternative embodiments, other blade geometries may also be practical, which allow scrub and grasses to be cut.

As shown in FIGS. 4 and 5, the cutting blade 20 has an average width c, which corresponds to the average distance, over the length a of the blade edge 25, 25′, of the two cutting edges 36, 36′ from one another. If the cutting blade 20 has only one blade edge 25, the average distance c between the cutting edge 36 of the one blade edge 25 and the particular longitudinal side 29′ of the cutting blade 20 on which a blade edge is not arranged is intended to be measured. Furthermore, the cutting blade 20 has a height d, measured perpendicularly to the cutting plane 35, which corresponds to the average distance, along the length a of the blade edge 25, 25′, between the top side 30 and the bottom side 31 of the cutting blade 20. The width c of the cutting blade 20 corresponds to at least twice, preferably at least three times, in particular at least four times the height d of the cutting blade 20. The length a of the blade edge 25, 25′ corresponds preferably to at least twice the width c of the cutting blade 20.

The base body 21, shown in FIG. 3, of the cutting blade 20 and the blade edge 25, 25′ are formed entirely from a biodegradable natural material. A biodegradable natural substance is a substance of natural origin (for example wood, wood fibers) which has not been chemically modified and, according to DIN EN 13432, should be considered to be degradable without testing. In the context of this application, biodegradable natural substances also include wood materials in which the content of binding agent is negligible, provided that the latter is preferably less than 30%, in particular less than 20%, advantageously less than 10% of the mass of the wood material. The use of a biodegradable natural substance ensures an environmentally friendly use of the cutting blade 20. The abrasion at the cutting blade 20 that arises during the cutting operation drops to the ground and biodegrades. The cutting blade 20 shown in the embodiment according to FIG. 3 is formed in one piece, and accordingly the blade edge 25, 25′ is formed on the base body 21 of the cutting blade 20. The embodiment of the cutting blade 20 according to FIG. 3 consists preferably of a wood material, in particular of hardwood, preferably beech, oak or ash. As a result, the base body 21 and blade edge 25, 25′ have a sufficiently high strength to ensure a long service life of the cutting blade 20.

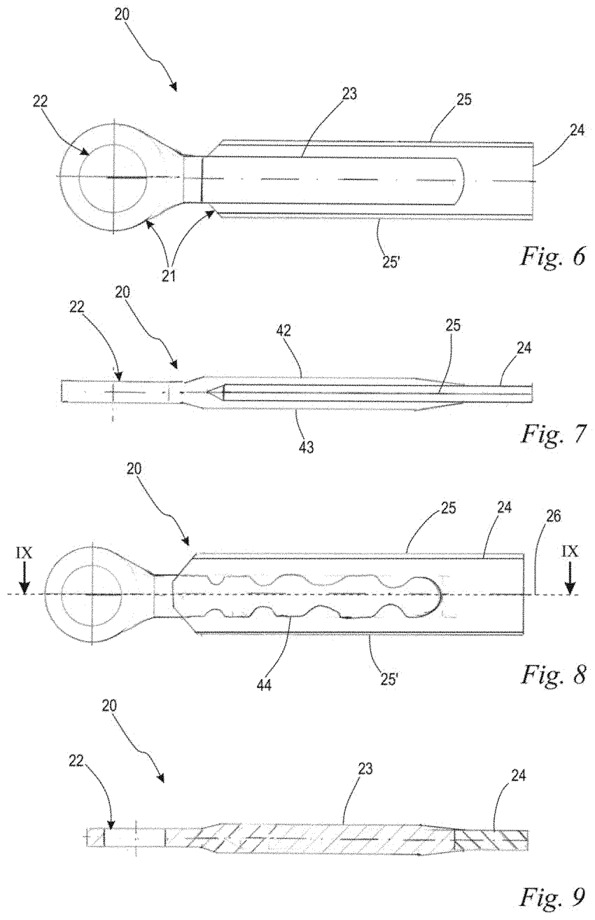

FIG. 6 shows a further embodiment of the cutting blade 20 according to the disclosure, the base body 21 comprising a carrier 23 and a cutting insert 24. The cutting insert 24 is held in the carrier 23. Arranged on the cutting insert 24 is the blade edge 25, 25′. The blade edge 25, 25′ consists of a biodegradable material. In addition to biodegradable natural materials, biodegradable materials also include the biodegradable plastics according to DIN EN 13432. Biodegradability means that a material has to have largely biodegraded, in particular to an extent of at least 70%, preferably to an extent of at least 90%, into water, carbon dioxide and biomass after a prescribed time, under defined temperature, oxygen and moisture conditions in the presence of microorganisms or fungi. Biodegradable plastics consist of polymers that can be decomposed by microorganisms such as fungi or bacteria, by means of enzymes under certain conditions. As a result of the plastic being fully degraded, the production of microplastic is avoided. Biodegradable plastics include in particular the plastics polyhydroxyalkanoate (PHA), polyhydroxybutyrate (PHB), polyhydroxyvalerate (PHV), polylactide (PLA), thermoplastic starch (TPS) or starch blends, cellophane, degradable polyester, polycaprolactone (PCL), polybutylene adipate terephthalate (PBAT), polybutylene succinate (PBS). The biodegradable material is preferably Arboform®. The material consists 100% of renewable raw materials and is biodegradable. Constituents of this material are lignin and natural fibers such as flax, hemp or other fiber plants and natural additives. The carrier 23 of the base body 21, by contrast, consists at least partially, in particular entirely of a non-biodegradable plastic. Such a plastic is preferably polyamide (PA).

In the embodiment according to FIG. 6, the blade edge 25, 25′ is formed on the cutting insert. Accordingly, the cutting insert 24 and the blade edge 25, 25′ are formed in one piece. The cutting insert 24 is formed preferably from a biodegradable natural material, in particular from a wood material, preferably from a hardwood.

In an alternative embodiment, the blade edge 25, 25′ can be formed directly on the carrier 23. In particular biodegradable plastics have only a low strength. Thus, the blade edge 25, 25′ is formed preferably from such a biodegradable plastic which, on account of the low strength, is subject to a high level of wear during operation of the cutter head 2. The carrier 23 is formed from a non-biodegradable plastic with a high strength and serves as a support structure for the blade edge 25, 25′. The carrier 23 is not configured to be a wearing part. If the blade edge 25, 25′ is worn, it can be replaced.

As shown in FIGS. 6 and 7, the fastening arrangement 22 for fastening the cutting blade 20 to a cutter head 2 is formed on the carrier 23. The carrier 23 comprises a first leg 42 and a second leg 43. The cutting insert 24 is held between the first leg 42 and the second leg 43 of the carrier 23. The cutting insert 24 is overmolded in the embodiment by the first leg 42 and the second leg 43. Alternatively, the cutting insert 24 may also have been adhesively bonded to the carrier 23. In an alternative embodiment that is not illustrated, it is also possible for connecting bolts to be provided, which pass through the carrier 23 and the cutting insert 24 and as a result connect them together in a form-fitting manner. In an alternative configuration of the carrier 23, the two legs 42, 43 can be formed in a laterally closed manner, such that the carrier 23 forms a receiving pocket for the cutting insert 24.

In an alternative configuration of the cutting blade 20 according to FIGS. 8 and 9, the cutting insert 24 has a cutout 44, which forms undercuts in the longitudinal direction 26 of the cutting blade 20. The carrier 23 has been molded in the cutout 44 of the cutting insert 24 and as a result connected to the cutting insert 24 in a form-fitting manner in the longitudinal direction 26 of the cutting blade 20. The geometry of the cutout is intended to be adapted to the forces to be transmitted between the carrier 23 and the cutting insert 24.

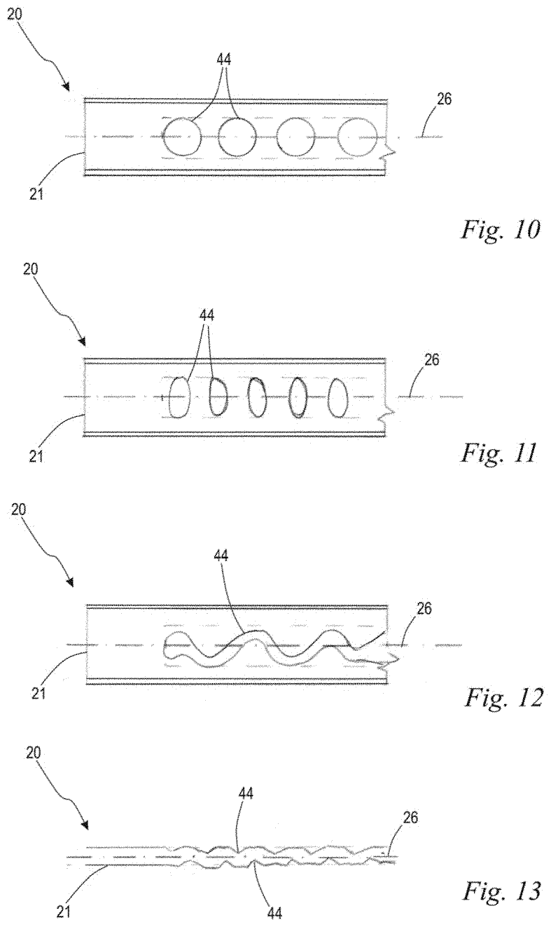

FIGS. 10 to 13 show embodiment variants of the cutting blade 20, in which the base body 21 has corresponding cutouts 44 for the form-fitting connection between the cutting insert 24 and carrier 23. The carrier 23 is injection-molded onto the cutting insert 24, the cutouts 44 being filled by the material of the carrier 23. In the process, the carrier 23 and the cutting insert 24 form a form-fitting connection. In FIG. 10, four cutouts 44 in the form of circular openings are provided in the cutting insert 24. The cutouts 44 are arranged one after another in the longitudinal direction 26 of the cutting blade 20. It may be expedient to provide a different arrangement, number, shape and size of the cutouts 44. Thus, in the embodiment of the cutting blade 20 according to FIG. 11, five elliptical cutouts 44 arranged one after another are provided in the cutting insert 24. In the embodiment of the cutting blade 20 according to FIG. 12, a single, serpentine cutout 44 is provided, which extends in the longitudinal direction 26 of the cutting blade 20. Alternatively, the cutouts 44, as shown in FIG. 13, can be configured such that a kind of fluting is formed on the cutting insert 24. The cutouts 44 can be formed on the base body 21 of the cutting blade 20, in particular on the carrier 23 and/or on the cutting insert 24. The cutouts 44 can also be provided in the base body 21 in order to reduce the weight or to increase the elasticity.

In a further embodiment of the cutting blade 20, relief slots are provided, which are formed in an analogous manner to the cutouts 44 (FIGS. 10 to 12) in the cutting insert 24. Such relief slots bring about elastic deflection of the blade edge 25, 25′. In particular in the case of cutting inserts 24 made of wood, the relief slots make the blade edge 25, 25′ flexible, resulting in the blade edge 25, 25′ being relieved of load. As a result, the service life of the blade edge 25, 25′ and of the cutting insert 24 is increased.

The cutting blade 20 according to the disclosure is not limited to the configuration illustrated in the figures, namely with the longitudinal sides 29, 29′ of the base body 21 oriented parallel to one another. In an alternative configuration of the cutting blade 20, it may be expedient to provide a crescent-shaped base body 21. It may also be expedient, as illustrated by dashed lines in FIG. 3, to provide an at least partially trapezoidal base body 21. In such an alternative embodiment of the cutting blade 20, the longitudinal sides 29, 29′ extend toward one another in the direction of the second end face 28 of the base body 21, with the result that the width c of the base body 21 reduces in the direction away from the fastening arrangement 22. It may be expedient to provide, in addition to the blade edge 25, 25′, further cutting elements, for example spike-like cutters, which exhibit the same material as the blade edge 25, 25′ on the base body 21. In a further embodiment according to the disclosure, the cutting blade 20 is in the form of a double blade, in which the fastening arrangement 22 is arranged centrally between the first end face 27 and the second end face 28. The double blade comprises at least two blade edges 25, 25′, the one of the two blade edges being arranged on the base body 21 between the fastening arrangement 22 and the first end face 27 in the cutting direction and the other of the two blade edges being arranged on the base body 21 between the fastening arrangement 22 and the second end face 28 in the cutting direction. The double blade can also be fastened directly to an output shaft of the handheld work apparatus 1.

Alternatively, the cutting blade 20 according to the disclosure can also be used on a lawnmower or on some other work apparatus for cutting lawns and/or scrub. Such work apparatuses also include non-handheld work apparatuses, in particular robotic lawnmowers, preferably lawn tractors. In an alternative embodiment, the cutting blade 20 can also be in the form of a cutting disk. Accordingly, the base body 21 has the shape of a circular disk, the blade edge 25 being formed at the circumference of the base body. The blade edge 25 can likewise be formed in a circular manner. A serrated blade edge 25 or other geometries of the blade edge 25 may also be expedient.

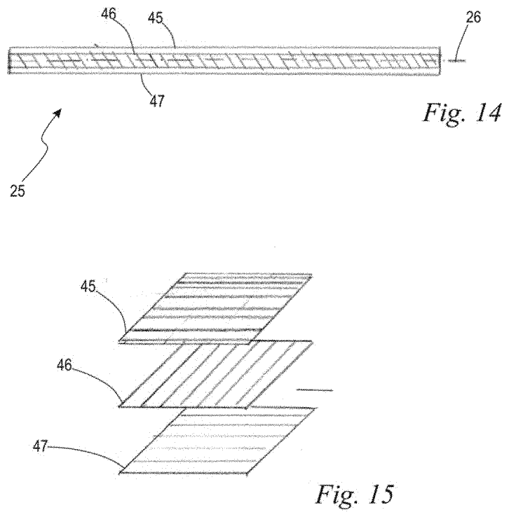

In FIGS. 14 and 15, the blade edge 25 is in the form of a self-resharpening edge. The blade edge 25 comprises a first outer layer 45, a second outer layer 47, and an inner layer 46 arranged between the first outer layer 45 and the second outer layer 47. The inner layer 46 has a higher strength than the first outer layer 45 and the second outer layer 47. The different strengths of the cutting layers result in the individual cutting layers wearing differently. During operation of the cutting blade 20, the outer layers 45, 47 of the blade edge 25 wear more quickly than the inner layer 46, resulting in a wedge-like edge geometry of the blade edge 25. In order to achieve the different strengths of the cutting layers, the outer layers 45, 47 are preferably made from a softwood and the inner layer 46 from a hardwood. Alternatively, the cutting layers can be made from the same materials and differ only in the orientation of the material fibers. Thus, the outer layers 45, 47 consist of a material with fibers oriented longitudinally with respect to the blade edge 25, while the inner layer 46 consists of a material with fibers oriented transversely with respect to the blade edge 25. The materials with the fibers oriented longitudinally with respect to the blade edge 25 wear much more quickly than the inner layer 46 consisting of the material with the fibers oriented transversely with respect to the blade edge 25. Of course, the different strengths of the outer layers can be formed by a combination of different materials and differently oriented fibers.

The blade edge 25, 25′ of the cutting blade 20 is preferably treated to provide protection against moisture. In particular for a blade edge 25, 25′ made of a wood material, the blade edge 25, 25′ is treated to be water repellent. Accordingly, the blade edge 25, 25′ can be covered with water-repellent substances, in particular with an oil or a wax, or be provided with a water-repellent coating. The same water-repellent treatment should preferably be provided on the base body 21, in particular on the cutting insert 24, of the cutting blade 20, as long as these consist of a wood material.

The cutter head 2 shown in FIG. 2 includes a fastening receptacle (not illustrated in more detail) for fastening the cutting blade 20. The fastening receptacle is provided on the main body 13 of the cutter head 2 and cooperates with the fastening arrangement 22 of the cutting blade 20. In a preferred embodiment of the cutter head 2, the fastening receptacle is in the form of a bearing pin and the fastening arrangement 22 of the cutting blade 20 is in the form of the fastening opening 32. The bearing pin engages through the fastening opening 32, the cutting blade 20 preferably being held on the bearing pin so as to be pivotable in a pivot plane arranged perpendicularly to the rotational axis 14. In an alternative embodiment of the cutter head 2, the fastening receptacle can also be formed by two clamping jaws that keep the cutting blade 20 clamped to the fastening arrangement. The clamping jaws are preferably in the form of catches, which, as the centrifugal force acting on the cutting blade 20 increases, increase the clamping force by way of a lever mechanism. In a further, alternative embodiment, the fastening receptacle can be in the form of an opening through which the cutting blade 20 projects. The cutting blade 20 is formed in a thicker manner at its fastening arrangement 22 such that the cutting blade 20 is held at the receiving opening of the cutter head 2 via the fastening arrangement 22. In such a variant, the fastening arrangement 22 is preferably formed in a wedge-like manner, in particular as a retaining shoulder.

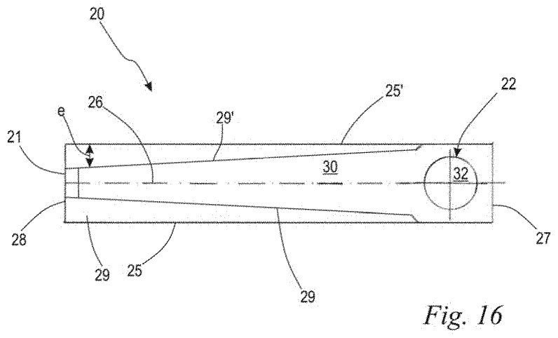

FIG. 16 shows a further embodiment of the cutting blade 20 according to the invention. The blade edge 25, 25′ has an edge width e, which is measured in the cutting plane 35 perpendicularly to the longitudinal axis 26 of the cutting blade 20. The edge width e increases as it extends away from the fastening arrangement 22 in the direction of the longitudinal axis 26. The blade edge 25, 25′ consists of biodegradable material, whereas the base body 21 is made at least in part of a non-biodegradable plastic. As a result of such a configuration of the blade edge 25, 25′, more material that is able to be worn is available in the direction of the second end face 28 of the cutting blade 20. This is advantageous, since with increasing distance from the fastening arrangement 22, the cutting speed also increases. With increasing cutting speed, the load on the blade edge and thus wear also increases. Accordingly, more biodegradable material should be used preferably in the regions of the cutting blade 20 that are subject to a higher cutting speed and thus also to a high level of wear. The use of biodegradable material is not limited to the blade edge 25, 25′ but can also be present at the cutting insert 24. In addition, a front edge 37, which is preferably likewise made of a biodegradable material, is provided at the second end face 28 of the cutting blade 20. The front edge 37 extends from one longitudinal side 29 to the other longitudinal side 29′.

In an independent inventive concept, the blade edge 25, 25′ consists at least partially, in particular entirely of a metal, wherein the base body 21 consists at least partially of a non-biodegradable plastic. It may be expedient to form the blade edge 25, 25′ from a material combination comprising a biodegradable material and a metal. In this way, the highly loaded regions of the blade edge 25, 25′ can be provided for example with a metal covering, and the less loaded regions can be made of the biodegradable material. The blade edge 25, 25′ can be formed for example only by a metal cladding that is formed from a thin metal layer. A metal blade edge 25, 25′ has the advantage that it is not subjected to abrasive wear when cutting scrub, grass or the like. Thus, wear at the blade edge 25, 25′ can be avoided. The use of a blade edge 25 that consists at least partially of metal can be particularly advantageous in cutting tools that are operated at a low rotational speed of less than 5000 revolutions per minute.

In an independent inventive concept, the main body 13 of the cutter head 2 consists at least partially, in particular entirely of a biodegradable material. Preferably, the regions of the main body 13 that are subjected to wear by the working environment during operation of the cutter head 2 consist of a biodegradable material. These include in particular the components of the cutter head 2 that form the outer face of the cutter head 2. The main body 13 of the cutter head 2 is formed from a lower main-body part 17 that faces the ground 12 in the working posture of the work apparatus 1 and from an upper main-body part 18 facing the work apparatus. In particular, during operation of the cutter head 2, the lower main-body part 17 is repeatedly in contact with the ground 12, with scrub, grass or the like, with the result that the lower main-body part 17 is subjected to increased wear. Therefore, the lower main-body part 17 is preferably made at least partially, in particular entirely of a biodegradable material. The lower main-body part 17 forms the underside 16 of the cutter head 2. The lower main-body part 17 also includes for example a protective undercoating of the cutter head 2. If the cutter head 2 comprises an advancing device for unreeling a cutting line from a line reel, the advancing element of the advancing device, known as the bumper, which is arranged on the underside 16 of the cutter head 2, is a constituent part of the lower main-body part 17. In order to unreel the cutting line from the line reel during operation of the cutter head 2, the bumper is knocked on the ground 12. The bumper is preferably produced from a biodegradable material. The abrasion that arises when the ground 12 makes contact with the bumper is thus biodegradable and therefore particularly environmentally friendly.

It is understood that the foregoing description is that of the preferred embodiments of the invention and that various changes and modifications may be made thereto without departing from the spirit and scope of the invention as defined in the appended claims.

What is claimed is:

1. A cutting blade for a cutter head, the cutting blade comprising:
a base body having a fastening arrangement for attaching said cutting blade to the cutter head;
said base body further having a blade edge; and,
said base body and said blade edge being made of a biodegradable natural material.

2. The cutting blade of claim 1, wherein said biodegradable material is a material selected from the group including biodegradable natural materials and biodegradable plastics.

3. The cutting blade of claim 1, wherein said biodegradable material of said blade edge is wood including a hardwood.

4. The cutting blade of claim 1, wherein the blade edge is formed on said base body.

5. The cutting blade of claim 1, wherein said blade edge and said base body are formed in one piece and made of the same material.

6. The cutting blade of claim 1, wherein the base body comprises a carrier and a cutting insert; the cutting insert is held by said carrier; and, said blade edge is arranged on said cutting insert.

7. The cutting blade of claim 6, wherein said carrier is formed from a biological non-degradable plastic.

8. The cutting blade of claim 6, wherein the cutting insert is made of a biodegradable material.

9. The cutting blade of claim 6, wherein the blade edge is formed on said cutting insert and said cutting insert and said blade edge are formed in one piece from the same material.

10. The cutting blade of claim 6, wherein the cutting insert is at least partially overmolded by said carrier.

11. The cutting blade of claim 6, wherein said cutting blade defines a longitudinal direction and said cutting insert is held on said carrier in a form-fitting manner in said longitudinal direction of said cutting blade.

12. The cutting blade of claim 1, wherein said base body has at least one cutout provided therein.

13. The cutting blade of claim 12, wherein said cutout is a slot or slit.

14. The cutting blade of claim 1, wherein the blade edge is formed from two outer layers and an inner layer arranged between said two outer layers; and, said outer layers have a strength less than the strength of said inner layer.

15. The cutting blade of claim 1, wherein the blade edge has a water-repellent coating.

16. A cutting blade for a cutter head, the cutting blade comprising:
a base body having a fastening arrangement for attaching said cutting blade to the cutter head;
said base body further having a blade edge; and,
said base body being made of a non-biodegradable plastic and said blade edge being made at least in part of a biodegradable material.

17. The cutting blade of claim 16, wherein said biodegradable material is a material selected from the group including biodegradable natural materials and biodegradable plastics.

18. The cutting blade of claim 16, wherein said blade edge is made of wood including hardwood.

19. The cutting blade of claim 16, wherein the blade edge is formed on said base body.

20. The cutting blade of claim 16, wherein the base body comprises a carrier and a cutting insert; the cutting insert is held by said carrier; and, said blade edge is arranged on said cutting insert.

21. The cutting blade of claim 20, wherein said carrier is formed from a biological non-degradable plastic.

22. The cutting blade of claim 20, wherein the cutting insert is made of a biodegradable material.

23. The cutting blade of claim 20, wherein the blade edge is formed on said cutting insert and said cutting insert and said blade edge are formed in one piece from the same material.

24. The cutting blade of claim 20, wherein the cutting insert is at least partially overmolded by said carrier.

25. The cutting blade of claim 20, wherein said cutting blade defines a longitudinal direction and said cutting insert is held on said carrier in a form-fitting manner in said longitudinal direction of said cutting blade.

26. The cutting blade of claim 16, wherein said base body has at least one cutout provided therein.

27. The cutting blade of claim 26, wherein said cutout is a slot or slit.

28. The cutting blade of claim 16, wherein the blade edge is formed from two outer layers and an inner layer arranged between said two outer layers; and, said outer layers have a strength less than the strength of said inner layer.

29. The cutting blade of claim 16, wherein the blade edge has a water-repellent coating.

30. A cutter head for a brushcutter, the cutter head comprising:
a main body defining a rotational axis and being configured to be rotatably driven about said rotational axis during operation of said brushcutter;
a cutting blade;
said main body having at least one attachment receptacle for receiving and holding said cutting blade; and,
said cutting blade including:
a base body having a fastening arrangement for attaching said cutting blade to the cutter head;
said base body further having a blade edge; and,
said base body and said blade edge being made of a biodegradable natural material.

31. The cutter head of claim 30, wherein the cutter head has an underside facing toward the ground when said brushcutter is in a working position; and, said underside of said cutter head is made of a biodegradable material.

32. A cutter head for a brushcutter, the cutter head comprising:
a main body defining a rotational axis and being configured to be rotatably driven about said rotational axis during operation of said brushcutter;
a cutting blade;
said main body having at least one attachment receptacle for receiving and holding said cutting blade; and,
said cutting blade including:
a base body having a fastening arrangement for attaching said cutting blade to the cutter head;
said base body further having a blade edge; and,
said base body being made of a non-biodegradable plastic and said blade edge being made at least in part of a biodegradable material.

33. The cutter head of claim 32, wherein the cutter head has an underside facing toward the ground when said brushcutter is in a working position; and, said underside of said cutter head is made of a biodegradable material.
